(19) United States
(12) Patent Application Publication
(10) Pub. No.: US 2006/0221889 A1
(43) Pub. Date: Oct. 5, 2006

(54) Data communication system

(76) Inventors: Scott D. Murdock, Seattle, WA (US); Robert Michael Reagan, Westlake Village, CA (US); Simon Westbrook, (US); Kim Blake Peterson, Camarillo, CA (US); Roger T. Haas, Scotts Valley, CA (US)

Correspondence Address: FISH & RICHARDSON P.C., PO BOX 1022, MINNEAPOLIS, MN, 55440-1022, US

(21) Appl. No.: 11/368,353

(22) Filed: Mar. 3, 2006

Related U.S. Application Data
(63) Continuation-in-part of application No. 10/400,294, filed on Mar. 25, 2003.
(60) Provisional application No. 60/369,450, filed on Apr. 1, 2002.

(51) Int. Cl. H04Q 7/00

(52) U.S. Cl. 370/328

(57) ABSTRACT

Systems and methods for wireless communications are provided. In one implementation a communications system is provided. The communications system includes a wireless access point connected to a public switched telephone network “PSTN”. The wireless access point is configured to provide wireless communication allowing a wireless user access device to communicate data through the PSTN connection. The communications system also includes a device coupled to the wireless access point. The device has one or more primary functions unrelated to public communication.

### CROSS-REFERENCE TO RELATED APPLICATION

This application is a continuation-in-part of U.S. patent application Ser. No. 10/400,294, filed on Mar. 25, 2003, which claims priority to U.S. Provisional Application No. 60/369,450, filed Apr. 1, 2002, both of which are hereby incorporated in their entirety.

### BACKGROUND

The present specification relates to data communication.

A conventional public switched telephone network (“PSTN”) provides circuit switched communications between devices (e.g., private telephones). In addition to private telephones, conventional public devices also provide access to the PSTN from public locations, for example, public pay telephones for providing voice communications. Other devices require access to the PSTN network, for example, automated teller machines (“ATMs”) and particular security systems.

Some conventional devices allow simultaneous voice and computer communication on a PSTN local loop (e.g., digital subscriber line (“DSL”) technology). Typically, the devices are combined with a PSTN local loop in a home or office environment to provide simultaneous network communications (e.g., Internet access) and switched PSTN voice access without mutual interference.

PSTN bandwidth has increased with the advent of alternative technologies (e.g., mobile phones and other wireless technologies). Wireless technologies have been developed to provide data communications (e.g., network access to the PSTN) to users of wireless access devices.

### SUMMARY

Systems and methods for wireless communications are provided. In general, in one aspect, a communications system is provided. The communications system includes a wireless access point connected to a public switched telephone network “PSTN”. The wireless access point is configured to provide wireless communication allowing a wireless user access device to communicate data through the PSTN connection. The communications system also includes a device coupled to the wireless access point. The device has one or more primary functions unrelated to public communication.

The system can include one or more of the following features. The communications system can further include a telephone module configured to provide for PSTN communication from the device simultaneous to data communication by the wireless access point over the PSTN. The communications system can further include a splitter connected to the PSTN connection, the splitter providing PSTN connections to both the telephone module and the wireless access point. The telephone module can be connected to the PSTN connection. The telephone module can be coupled to the wireless access point and communicates with the PSTN through the wireless access point.

The communications system can further include a splitter integrated with the wireless access point and connected to the PSTN connection to provide PSTN connections to both the device and the users of the wireless access point. The communications system can further include a filter connected to the PSTN connection and configured to provide a PSTN connection with suppressed interference.

The device can consist of one or more of the following, an automated teller machine, a security device, or a vending machine. The wireless access point can be further configured to enable the wireless user access device to connect to a communications network through the PSTN connection. The communications network can be the Internet or a private network. The wireless access point can include equipment conforming to a wireless standard including an IEEE 802.11 standard, Bluetooth standard, or cellular standard.

In general, in one aspect, a kit for retrofitting a device to provide wireless data communication is provided. The kit includes a wireless access point configured to be connected to a public switched telephone network (“PSTN”) of a device. The wireless access point is operable to provide wireless communication for a wireless user access device to communicate data using the PSTN connection. The wireless access point can provide data communication through the PSTN without interfering with the operation of the device. The device also includes a linking module including one or more applications for linking the wireless access point to the device.

Implementations of the kit can include one or more of the following features. The kit can further include a splitter configured to be connected to the PSTN connection of the device to provide PSTN connections to both telephone equipment of the device and to the wireless access point. The wireless access point of the kit can be further configured to be connected to telephone equipment of the device to provide PSTN communications for the device substantially simultaneous to data communications of the wireless user access device. The wireless access point of the kit can be further configured to enable the wireless user access device to connect to a communications network through the PSTN connection. The kit can further include a filter configured to be connected to the PSTN connection for suppression of interference. The communications network can be the Internet or a private network.

In general, in one aspect, a method of providing wireless data communication is provided. The method includes providing a device including a PSTN connection and coupling a wireless access point to the device. The method also includes coupling the wireless access point to a public switched telephone network (“PSTN”). The wireless access point is configured to provide data communication for a user of a wireless access device through the PSTN without interfering with PSTN communications of the device.

In general, in one aspect, a method of providing wireless data communication is provided. The method includes receiving a wireless data signal from a wireless user at a wireless access point coupled to a device. The method also includes transmitting the data from the received wireless data signal to a network using a PSTN without interfering with the operation of the device, where the device provides private data communication.

Implementations of the method can include one or more of the following features. The method can further include receiving data from the PSTN for the user, converting the received data into a wireless signal and transmitting the wireless signal to the user. The method can further include determining whether received data is directed to a wireless user or a device coupled to the wireless access point where the device provides non-public communication.

In general, in another aspect, a communications system is provided. The communication system includes a wireless access point connected to a PSTN. The wireless access point is configured to provide wireless communication allowing a wireless user access device to communicate data through the PSTN connection. The communications system also includes an automated teller machine coupled to the wireless access point, the device having one or more primary functions unrelated to public communication.

In general, in one aspect, a communications system is provided. The communications system includes a pay telephone connection to a PSTN. The system also includes data communications equipment connected to the pay telephone connection. The data communications equipment is configured to provide data communication through the PSTN. The system further includes the pay telephone connection to the PSTN operable to allow the data communication equipment to communicate data through the PSTN without interfering with a circuit switched telephone call placed through the pay telephone connection and a wireless access point connected to the data communications equipment. The wireless access point is configured to provide wireless communication to a wireless user access device.

The disclosed implementations provide one or more of the following advantages. Existing PSTN infrastructure can be used to provide data communications to users of wireless devices. Wireless access can be provided through devices positioned in public locations. Wireless functionality can be added to devices while minimizing the intrusion into the public space, for example, without being obtrusive, creating eyesores, or inserting new, unfamiliar structures. For example, wireless access points can be incorporated into existing devices having a PSTN connection including pay telephones, ATMs, and security devices. Other commonly found devices or structures, existing without a PSTN connection, can be configured to include a wireless access point with the addition of a PSTN connection including vending machines and outdoor signage. Thus, wireless data access can be provided to users through familiar and commonly seen devices such that there is no additional intrusion into the public space caused by the addition of the wireless functionality.

The public wireless access is provided through existing devices without interfering with the primary operation of the device. With the addition of a wireless access point, wireless communications can be provided from devices whose primary functionality does not include public communications over a PSTN, for example, the PSTN use of an ATM is private communication between the ATM and a financial institution. A number of wireless access points can be implemented in devices to provide a network of public wireless access. Local wireless access can be provided without requiring government permits or allocation of government controlled wireless frequencies.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows one implementation of a communication system for providing wireless access including a wireless access point.

FIG. 2 shows a detailed view of the device shown in FIG. 1.

FIG. 3 shows a method of wireless data communication.

FIG. 4 shows an implementation of a system for providing wireless access using a pay telephone.

Like reference numbers and designations in the various drawings indicate like elements.

### DETAILED DESCRIPTION

A data communications system is provided that includes a wireless access point configured to provide wireless network access to one or more users in a public location. The wireless access point can be provided through an existing device coupled to the PSTN. The wireless access point can be configured to provide wireless network access to users without interfering with the operation of a host device such as a pay telephone, an ATM, a security device, vending machine or other end device that includes, or can include PSTN access.

Wireless data communications can be provided in public locations to wireless users. The devices, which have been configured to provide wireless functionality, can also include functionality unrelated to PSTN communications.

System Architecture

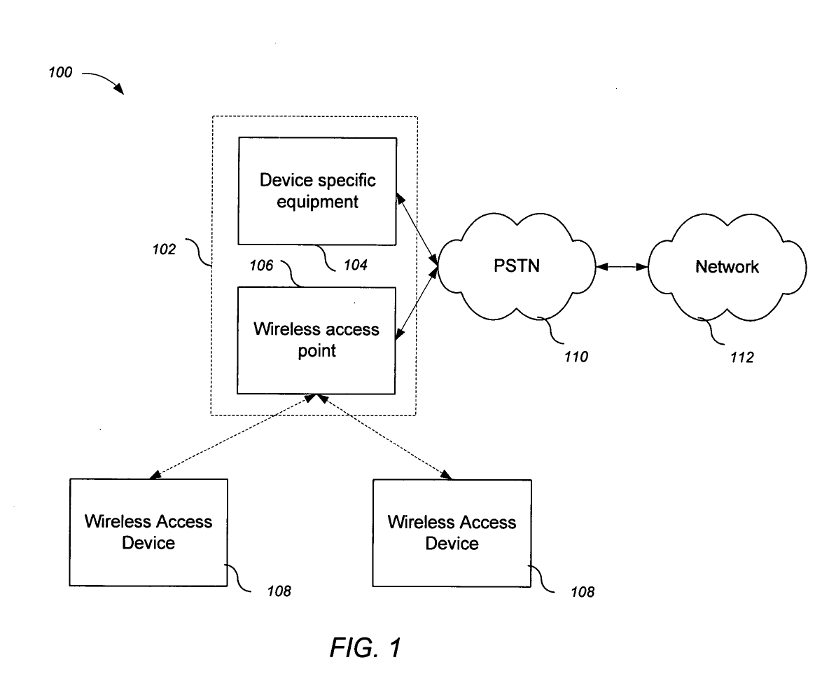

FIG. 1 shows a communication system 100 for data communication including a wireless access point 106. Communication system 100 includes device 102. The device 102 includes device specific equipment 104 and the wireless access point 106. The wireless access point 106 can provide data communications for one or more wireless access devices 108. The device is coupled to a network 112 through the PSTN 110.

Wireless access devices 108 provide a user with wireless data communications. Wireless access devices 108 include, for example, computers, personal data assistants (“PDAs”), and other wireless devices. Wireless access devices 108 can be configured to provide data communications using a number of different wireless systems including 802.11 “wi-fi” standard, Bluetooth, cellular, and other wireless systems.

Network 112 can include one or more computer networks, both public and private. The network 112 can include a virtual private network (“VPN”), local area network (“LAN”), wide-area network (“WAN”), the Internet, or other computer networks.

The device 102 is coupled to the PSTN 110. In one implementation, the device 102 represents a device commonly found in public locations, for example, building hallways and transportation terminals. The device 102 can provide a public structure configurable to connect with a communications network such as the PSTN 110. The device 102 includes, or can be adapted to include, components operable to provide particular functionality. For example, the device 102 can include connectivity components. Connectivity components connect the device 102 to one or more communication networks such as the PSTN 110. Wired connectivity can include copper wiring as well as fiber optic cables. Connectivity components can also include wireless connectivity to a communication network including radio frequency (“RF”) microwave, cellular, or other wireless communications systems. The device 102 can include two or more different connectivity components to provide multiple and redundant connectivity.

The device 102 can also include power components. Power components provide electrical power for operating components of the device 102. Power components can include connections to external power sources such as AC or DC line connections. Additionally, power can be supplied using internal power components, for example, from one or more batteries, fuel cells, solar panel, or other source. The device 102 can include more than one power component to provide a redundant power supply.

The device 102 can include other components. For example, the device 102 can include software or hardware (e.g., an application specific integrated circuit) providing logic for performing one or more functions. A display component can be included to provide interaction with a user. Electrical surge protection components can be included to provide protection from electrical surges both in-line and externally generated (e.g., lightning). Additionally, the device 102 can include components to provide lighting for the device 102. Furthermore, the device 102 can be weatherized for outdoor use.

In one implementation, the device 102 includes device specific equipment 104 having one or more primary functions other than to provide wireless data communication. The device specific equipment 104 can include the connectivity, power, and other components described above. Alternatively, one or more of the components can be provided as part of the wireless access point 106 and incorporated into the device 102. The device 102 can be, for example, a pay telephone, an ATM machine, a security device, public kiosk, or any other device, the function of which incorporates a PSTN connection.

For example, a pay telephone includes equipment for placing a circuit switched telephone call through the PSTN 110. An ATM machine includes equipment (e.g., a modem) for communicating data through the PSTN 110 associated with monetary transactions including account information, amounts withdraw and amounts deposited. A security device (e.g., an alarm system) communicates alarm signals through the PSTN 110. For example, when the security device detects a breach (e.g., a broken window), a signal can be sent by the security device using the PSTN 110 to communicate an alert. The ATM and security device, for example, do not provide public PSTN communications in contrast with the pay telephone functionality. Other devices can also be designed for use with a PSTN connection. For example, modern traffic lights can include data communication connections for providing traffic management.

In an alternative implementation, the device specific equipment 104 can function without a PSTN connection, such that a PSTN connection can be added to provide a network connection for the data communication through the wireless access point 106. For example, in one implementation, the wireless access point 106 can be incorporated into a vending machine to create a communication system 100 when coupled to the PSTN. Additional equipment can be added to provide the PSTN connection for the wireless access point 106. The device 102 can be a device whose functionality prior to the addition of the wireless access point does not involve PSTN communication at all.

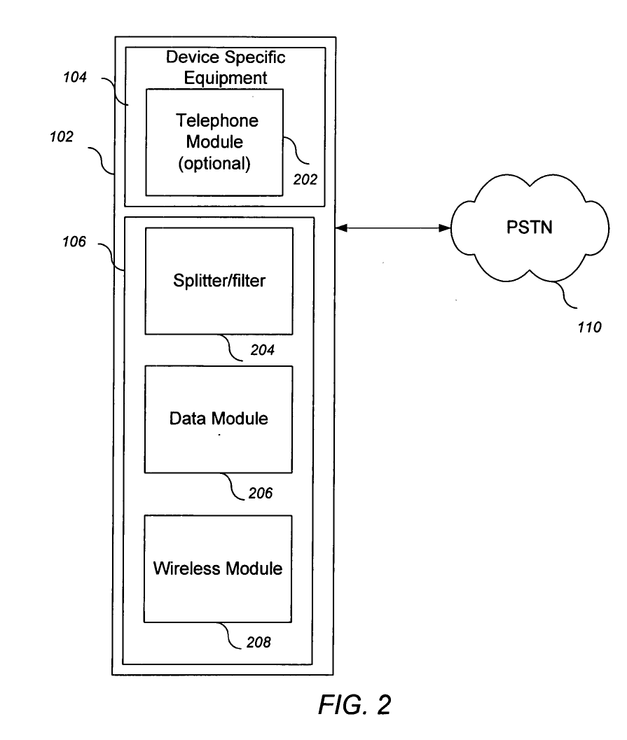

FIG. 2 shows a block diagram of the device 102 coupled to the PSTN 110. Device 102 includes device specific equipment 104 and wireless access point 106. The device specific equipment 104 controls operation of the primary functions of the device 102 separate from the wireless access point 106. The device specific equipment 104 can optionally include telephone module 202 for devices having existing telephonic functionality. Telephone module 202 includes equipment configured to connect with, and provide signals to, the PSTN 110, for example, through a wired or wireless connection.

The wireless access point 106 includes an optional splitter/filter module 204, a data module 206, and a wireless module 208. In one implementation, the optional splitter/filter module 204 can provide simultaneous connectivity for both the data module 206 in the wireless access point 106 and the telephone module 202. For example, the telephone module 202 can connect to the PSTN 110 using the splitter/filter module 204. The splitter/filter module 204 can be configured to separately maintain incoming and outgoing PSTN signals from both the telephone module 202 and the data module 206. Consequently, the telephone module 202 and the data module 206 can operate independently. Additionally, in another implementation, the splitter/filter module 204 can provide interference filtering for signals passing through the splitter/filter module 204 to or from the PSTN 110.

The data module 206 receives data signals from the PSTN 110 as well as from users of the communication system 100 through the wireless module 208. In one implementation, the data module 206 establishes and maintains connections to one or more networks through the PSTN 110. The data module 206 can be configured to manage data flow through the wireless access point 106 for one or more wireless users.

The wireless module 208 sends and receives wireless data. The wireless module 208 can include a transmitter and a receiver. The transmitter can broadcast wireless data signals over a particular range. The transmitter can receive data signals from the data module 206 and covert the data signals to wireless signals.

The receiver can receive data signals from one or more users within range of the wireless module 208. The receiver can convert the received wireless data signals into digital signals and relay the signals to the data module 206. One or more antennas can be included or coupled to the wireless module 208 for the transmission and reception of data signals. The transmission and reception range depends, in part, on the form of the wireless signal composition. For example, the wireless module can operate using a wi-fi standard, for example the IEEE 802.11 standard. Alternatively, the wireless module can be configured to operate using cellular, Bluetooth, ZigBee, Ultra Wideband, wireless WAN systems, or any other available wireless data systems.

Operation

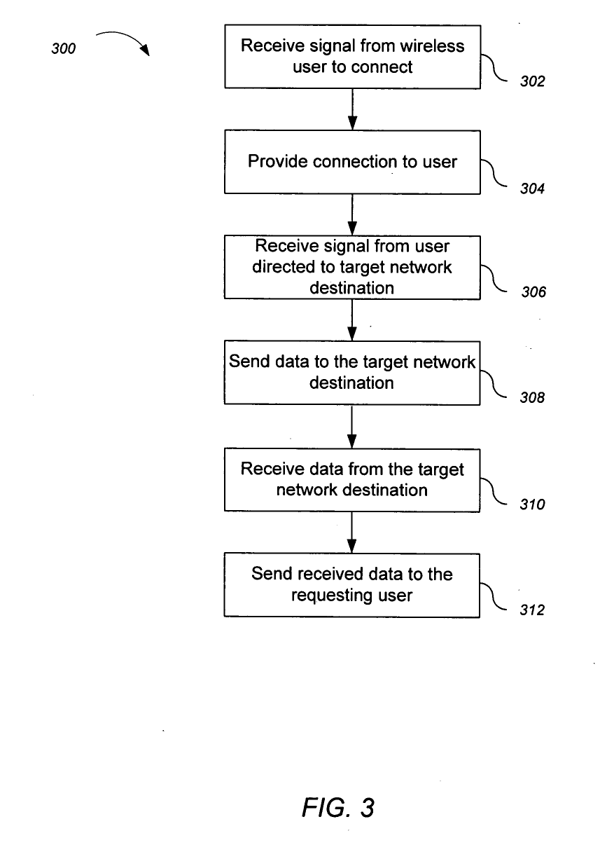

FIG. 3 shows a process 300 for using a communication system (e.g., communication system 100) where a wireless access point (e.g., wireless access point 106) has been attached to or integrated into a device having a primary functionality unrelated to wireless communications (e.g., a pay telephone). In other implementations, the device's functionality is unrelated to any public communication whether wireless or wired (e.g., an ATM or vending machine). When a user of a wireless access device (e.g., wireless access device 108) enters the range of the communication system, the wireless access point can receive a signal from the user (through the user's wireless access device) to connect to the communication system (step 302). In one implementation, the request to connect can include user identification information such as a user name and account information such as a password. The wireless access point can include access control and authorization functions (e.g., as part of the data module 206) to control access. If the user is eligible to connect, the wireless access point can provide a connection to the user (step 304) The wireless access point can then receive a data signal from the user to access a particular network or network destination (step 306). For example, the user can initiate an email session, or open a web destination using an Internet browser window. Alternatively, the user's signal can be to access a private network for example, using a virtual private network (“VPN”) providing secure data communications.

The wireless access point can transmit the received data from the user to the target network through a PSTN (e.g., PSTN 110), for example, using a data module (e.g., data module 206) connected to the PSTN (step 308). For example, the data module can process and transmit the received user data for transmission through the PSTN to the target network destination. The received user data, for example, can be a request to view a target Internet web destination.

The data module can receive data from a network destination through the PSTN (step 310). For example, a user requested web destination can be transmitted from the Internet to the data module of the wireless access point through the PSTN.

Upon receiving the data through the PSTN connection (e.g., the web site data), the data module can send or relay the data to the requesting user (step 312). The data module can provide data processing prior to providing the received data to the wireless module. The wireless module can convert the received data into wireless signals broadcast by a wireless transmitter. In one implementation, several users can simultaneously connect with the wireless access point. The wireless access point can differentiate between users such that each user receives the correct data. For example, the wireless access point can create sessions for each user, such that the data communications from each user are independent from other users.

In most implementations, the transmission and reception of data signals through the PSTN by the data module does not interfere with the operation of device specific equipment unrelated to the data communications provided by the wireless access point. A splitter (e.g., as part of a splitter/filter module 204) can separate data signals transmitted by the wireless access point and a telephone module of the device specific equipment. For example, the device specific equipment can be equipment for operating an ATM. The ATM can send and receive signals through the PSTN to manage ATM security, process user monetary requests, as well as to provide ATM status data (e.g., how much currency is stored in the ATM). In this example, the data communications provided by the wireless access point do not interfere with the ATM's communications such that the ATM functions are unaffected by the processes of the wireless access point.

In other implementations, the device specific equipment does not include any telephone equipment. A PSTN connection can be added to the device to provide connectivity for the wireless access point. For example, a vending machine does not require telephone communications for operation. The wireless access point can be integrated into the device without altering the functions of the non-telephonic device. As such, the vending machine, for example, can operate independently of a wireless access point integrated into the vending machine.

Pay Phone Implementation

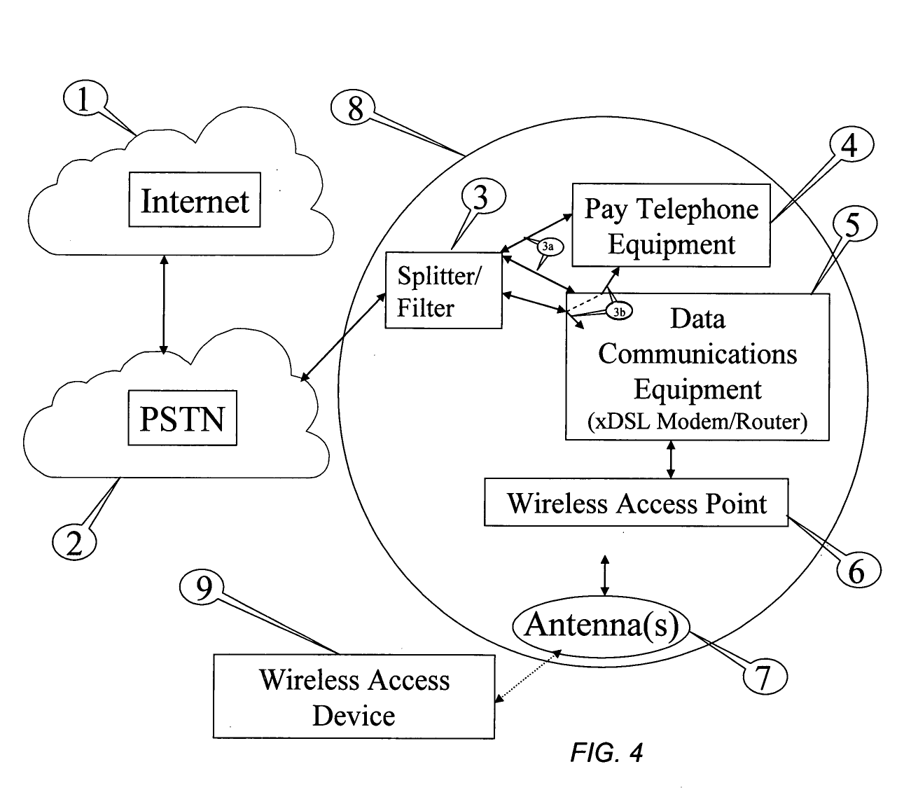

One implementation of a communication system where a wireless access point is connected to a pay telephone is shown in FIG. 4. A communication system 8 provides public wireless access to communications networks, such as Internet 1 through existing and new PSTN facilities 2. Wireless access includes various forms of communication, for example, both voice and computer data. The terms “data” and “data communication” include voice, video, text, e-mail, computer programs, script files, documents, messages, attachments, and any other type of information capable of being communicated.

Telephone equipment is connected to the PSTN network 2 to enable the placing of calls or interconnection to network systems, such as the Internet 1. Pay telephone equipment 4 is one example of telephone equipment coupled to the PSTN 2. Pay telephones can be placed in public locations to provide public access to the PSTN 2 for a fee. In one implementation, pay telephones include at least one PSTN local access loop.

An optional splitter/filter 3 can be connected between the PSTN 2 and the pay telephone equipment 4. The PSTN and telephone equipment can be connected, for example, using a two-wire or four-wire connection. The splitter/filter 3 is connected on one side to the PSTN 2 using, for example, a standard PSTN connection such as an RJ-11C jack. The splitter/filter 3 can provide one or more filtered connections to the PSTN 2. For example, the splitter/filter 3 can provide connections to both the pay telephone equipment 4 and data communications equipment 5. The splitter/filter 3 can provide simultaneous access to the PSTN 2 and network systems, such as the Internet 1, across a same PSTN local loop facility. In one implementation, the splitter/filter 3 can also provide filtering to reduce signal interference. The splitter/filter 3 can be coupled to the data communications equipment 5 and pay telephone equipment 4 in parallel as shown by connections 3a.

In one implementation a “plain old telephone system” (“POTS”) splitter can be used. The POTS splitter can allow the pay telephone local loop to be used for simultaneous high-speed data transmission (e.g., DSL) and single-line telephone service. POTS splitters can be active or passive. In one implementation a standard, off-the-shelf, passive splitter, commonly called a microfilter, is used for the splitter/fitter 3. The specific model and type of the splitter/fitter 3 for a particular implementation may be determined according to the PSTN providers' specifications.

In another implementation, the splitter/filter 3 can be integrated into system connectors or into sub-systems such as the xDSL modem/router. The xDSL modem/router 5 may connect to the PSTN 2, and then passively pass a PSTN connection to the pay telephone equipment 4. Reference numeral 3b depicts the serial data flow when the splitter/filter 3 is integrated with the data communications equipment 5.

The data communications equipment (e.g., the xDSL modem/router) 5 can communicate data received from a wireless access point 6 to the PSTN 2. Other implementations can use other data communications equipment, including, for example, cable modem equipment. The wireless access point 6 can include computer hardware and operating software to provide wireless data communication, e.g., hardware and software conforming to an IEEE 802.11 or other wireless standard. The wireless access point 6 connects to antenna(s) 7 for wireless signal transmission and reception. The specific type and orientation of the antenna(s) 7 can depend on the physical location and environment in which the access point 6 is placed.

Some or all of the components shown in FIG. 4 can optionally be combined into a single unit or sub-system. Furthermore, specific models of each of the components (modem/router 5, access point 6, and antenna 7) can be selected so as to accommodate the physical location of the overall system, requirements of the PSTN and Internet service provider(s) (“ISP(s)”) being used, and the wireless coverage needs of each location.

The communications system 8 can provide user access to communications networks, including, but not limited to, local area, wide area, and/or global computer networks, such as the Internet 1. The communications networks may be public or private (i.e., owned or operated by multiple or single entities). Authentication, access control and security systems, which are typically required for users to connect to a communications network, can be used.

One generalized example of a network access process using an embodiment of the invention can include the following steps. First a wireless user access device 9 can sense an available wireless connection with a network access point 6 (e.g., at a pay telephone) (or the user requests a connection and the wireless user access device 9 senses an available access point). The wireless access device 9 can then present the user with an authentication/validation screen, for example, on a display of the wireless user access device. The user can enter account information including an appropriate validation code or billing information (e.g., account name or credit card number). After the user has successfully connected, the user can access a communications network, such as the Internet, as provided by a service provider, (e.g., an ISP), and suitable billing tracking and monitoring processes can be initiated (e.g., timer, packet counter, or transaction billing). The user can retrieve or transmit information as desired and disconnect when finished. A billing log can be posed when the user disconnects.

The foregoing steps describe only one process for accessing the PSTN using a wireless access device. The actions described above do not necessarily have to be performed in the manner or order as shown to achieve the advantages of the present invention. Alternative network access processes using the invention may employ additional or fewer steps than described above.

Users with wireless equipped access devices 9 (e.g., 802.11 devices) can access network systems, such as the Internet 1, through the wireless technology, methods and procedures. Examples of wireless user access devices 9 include, but are not limited to: personal computers (including portable “laptop” computers), personal digital assistants (PDAs), Voice over IP (VoIP) hand-sets, and telematics devices.

In one implementation, the wireless access point is housed within a pay telephone. The pay telephone can be constructed to include the wireless access point or an existing pay telephone can be retrofitted to provide wireless data communication. Retrofitting an existing device such as a pay telephone may be provided using a kit comprising data communications and wireless access point equipment for installation into the device. Different implementations of a retrofitting kit may be provided to address different pay telephone configurations. In one implementation, a kit for retrofitting a pay telephone includes data communications equipment (e.g., an xDSL modem/router), and wireless access point hardware and software (e.g., 802.11) for providing wireless access point (with one or more antenna(s) as discussed above). The kit can also include an applications module that includes one or more applications or linking code configured to join the wireless access point with the existing device equipment.

The kit may also include a splitter or filter, or combination of the two, for installation into the pay telephone. In other implementations, the kit may also include replacement housing for the pay telephone to accommodate a change in form factor of the telephone necessitated by the addition of the data communications equipment and wireless access point.

In another implementation, the pay telephone equipment 4 shown in FIG. 4 can be disabled or removed from the telephone housing, thus leaving the pay telephone with only wireless data communication capabilities. For example, pay telephone equipment can be removed in locations having multiple pay telephones such that switched circuit access to the PSTN for conventional voice communication can be provided by other pay telephones, leaving the pay telephone configured with wireless data communication equipment to be dedicated exclusively to wireless data communication. An implementation of this can further include a replacement housing for the dedicated pay telephone that makes it more visible as an access point for wireless data communication. Such housing may use bold colors, styling, and/or signage. With a highly visible housing, consumers may more easily find and connect to the communication system 8.

Implementations can also be scaled by connecting multiple wireless access points and/or data communications equipment as needed. The communication system 8 can be configured to accommodate numerous users with simultaneous access to the PSTN 2 and communications networks, such as the Internet 1. In one implementation, the communication system 8 can be set up in public areas likely to have a number of users nearby for extended periods of time, for example, convention centers and transportation terminals. For instance, at an airport, people arriving early to catch an international flight may have several hours to wait for their flight. During that time, they may wish to access a computer network using the public wireless access system 8 to review news, download and respond to e-mails, communicate data, etc.

In another implementation, a number of instances of the communication system 8 can be positioned to create a network of wireless access over an extended area, for example, a building, a block, or entire sections of a town or city.

The terms “connected” and “connection,” as used to described the links between the wireless access point 6, the data communications equipment 5, the telephone equipment 4, the splitter/filter 3, and the PSTN 2, include both direct and indirect connections. An example of a direct connection is where a physical port of one equipment is wired or engaged with a physical port of another. An example of an indirect connection is where one equipment can communicate with another through a path that includes some intermediate equipment.

Further implementations can be dedicated to specific businesses or entities. For example, a corporate campus can choose to install or retrofit one or more pay telephones with the communication system 8 to provide their employees with mobile access to the corporation's communications networks, including corporate LANs or wide area networks (“WANs”), and/or the Internet. Another example is a university campus that replaces or retrofits pay telephones to provide students and faculty mobile access to the university's computer networks, including university LANs or WANs, and/or the Internet.

Implementations of the invention may also be designed for the bandwidth needs and/or level of demand of the location where the pay telephone is located. In some locations, users connecting to the communication system 8 may need only limited bandwidth for applications such as e-mail. The equipment of the communication system 8 may be configured for low bandwidth needs. In other locations, users may require higher bandwidth for applications such as video. The data communications equipment and wireless access points can be selected and installed to accommodate differing bandwidth demands.

It is also noted that not all devices need to have the same amount of equipment added to it to provide the communication system 8. For example, some pay telephones currently have computer communication capabilities and may need only certain equipment, such as a wireless access point, to be added. Other pay telephones, typically older installations, are not computer capable and may need components as shown or further components in addition to or in place of the components shown in FIG. 4. The foregoing description is not intended to be exhaustive or to limit the invention to the precise form illustrated in the drawings or as specifically described.

Further implementations of the invention can be achieved using combinations of the concepts discussed herein and thus are also considered part of the present invention. For example, the pay telephone equipment 4 may be connected to the data communications equipment 5 and configured to communicate voice data via the PSTN 2 using signals transmitted through the data communications equipment 5. One example of this is a pay telephone configured to provide voice telephone calls using VoIP technology and the data communications equipment discussed herein. The scope of the invention should therefore be determined in reference to the following claims and equivalents thereto.

A number of embodiments of the invention have been described. Nevertheless, it will be understood that various modifications may be made without departing from the spirit and scope of the invention. For example, in one implementation, the device is connected to a telecommunications network other than a PSTN. Accordingly, other embodiments are within the scope of the following claims.

What is claimed is:

1. A communications system comprising:
a wireless access point connected to a public switched telephone network (“PSTN”), the wireless access point configured to provide wireless communication allowing a wireless user access device to communicate data through the PSTN connection;
a device coupled to the wireless access point, the device having one or more primary functions unrelated to public communication.

2. The communications system of claim 1, further comprising a telephone module configured to provide for PSTN communication from the device simultaneous to data communication by the wireless access point over the PSTN.

3. The communications system of claim 2, further comprising a splitter connected to the PSTN connection, the splitter providing PSTN connections to both the telephone module and the wireless access point.

4. The communications system of claim 2, in which the telephone module is connected to the PSTN connection.

5. The communications system of claim 1, in which the telephone module is coupled to the wireless access point and communicates with the PSTN through the wireless access point.

6. The communications system of claim 5, further comprising a splitter integrated with the wireless access point and connected to the PSTN connection to provide PSTN connections to both the device and the users of the wireless access point.

7. The communications system of claim 1, where the device consists of one or more of the following, an automated teller machine, a security device, or a vending machine.

8. The communications system of claim 1, further comprising a filter connected to the PSTN connection and configured to provide a PSTN connection with suppressed interference.

9. The communications system of claim 1, in which the wireless access point is further configured to enable the wireless user access device to connect to a communications network through the PSTN connection.

10. The communications system of claim 9, in which the communications network is the Internet.

11. The communications system of claim 9, in which the communications network is a private network.

12. The communications system of claim 1, in which the wireless access point includes equipment conforming to a wireless standard including an IEEE 802.11 standard, Bluetooth standard, or cellular standard.

13. A kit for retrofitting a device to provide wireless data communication, comprising:
a wireless access point configured to be connected to a public switched telephone network (“PSTN”) of a device, in which the wireless access point is operable to provide wireless communication for a wireless user access device to communicate data using the PSTN connection, and where the wireless access point can provide data communication through the PSTN without interfering with the operation of the device; and
a linking module including one or more applications for linking the wireless access point to the device.

14. The kit of claim 13, further comprising a splitter configured to be connected to the PSTN connection of the device to provide PSTN connections to both telephone equipment of the device and to the wireless access point.

15. The kit of claim 13, in which the wireless access point is further configured to be connected to telephone equipment of the device to provide PSTN communications for the device substantially simultaneous to data communications of the wireless user access device.

16. The kit of claim 13, further comprising a filter configured to be connected to the PSTN connection for suppression of interference.

17. The kit of claim 13, in which the wireless access point is further configured to enable the wireless user access device to connect to a communications network through the PSTN connection.

18. The kit of claim 17, in which the communications network is the Internet.

19. The kit of claim 17, in which the communications network is a private network.

20. A method of providing wireless data communication, comprising:
providing a device including a public switched telephone network (“PSTN”) connection;
coupling a wireless access point to the device; and
coupling the wireless access point to the PSTN, in which the wireless access point is configured to provide data communication for a user of a wireless access device through the PSTN without interfering with PSTN communications of the device.

21. A method for providing wireless data communication, comprising:
receiving a wireless data signal from a wireless user at a wireless access point coupled to a device;
transmitting the data from the received wireless data signal to a network using a public switched telephone network (“PSTN”) without interfering with the operation of the device, where the device provides private data communication.

22. The method of claim 21, further comprising:
receiving data from the PSTN for the user;
converting the received data into a wireless signal; and
transmitting the wireless signal to the user.

23. The method of claim 22, further comprising:
determining whether received data is directed to a wireless user or a device coupled to the wireless access point, the device providing non-public communication.

24. A communications system comprising:
a wireless access point connected to a public switched telephone network (“PSTN”), the wireless access point configured to provide wireless communication allowing a wireless user access device to communicate data through the PSTN connection;
an automated teller machine coupled to the wireless access point, the device having one or more primary functions unrelated to public communication.

25. A communications system comprising:
a pay telephone connection to a public switched telephone network (“PSTN”);
data communications equipment connected to the pay telephone connection, in which the data communications equipment is configured to provide data communication through the PSTN; and
the pay telephone connection to the PSTN operable to allow the data communication equipment to communicate data through the PSTN without interfering with a circuit switched telephone call placed through the pay telephone connection; and
a wireless access point connected to the data communications equipment, in which the wireless access point is configured to provide wireless communication to a wireless user access device.
